(19) United States
(12) Patent Application Publication
(10) Pub. No.: US 2004/0148738 A1
(43) Pub. Date: Aug. 5, 2004

(54) Bracket for mounting a center pivot shower door

(76) Inventor: Larry J. Moss, Jasper, GA (US)

Correspondence Address: POWELL, GOLDSTEIN, FRAZER, & MURPHY LLP, 16TH FLOOR, 191 PEACHTREE STREET, NE, ATLANTA, GA, 30303-1736, US

(21) Appl. No.: 10/355,640

(22) Filed: Jan. 31, 2003

(51) Int. Cl. E05D 1/00

(52) U.S. Cl. 16/221

(57) ABSTRACT

A bracket assembly for a center pivot door, comprising a support bracket comprising a generally flat plate, a ledge extending perpendicularly from the plate and having an aperture defined therein, two bosses extending perpendicularly from the plate, each boss having an aperture defined therein; an attachment plate comprising a generally flat member having a pair of apertures defined therein which can be aligned with the boss apertures; and, a pin having an annular ring extending therefrom, a portion of which rotatably fits within the ledge aperture. The support bracket and attachment plate are placed on either surface of a door, such as a shower door and screws are used to join the support bracket and attachment plate sandwiching the door therebetween. A second support bracket and attachment plate are mounted to the door frame. A pin is inserted into the ledge apertures of both support plates for pivotably coupling the bracket assembly to a second support bracket-attachment plate assembly so that the door can pivot about the pin axis. Bracket assemblies are mounted on the top and bottom of the door and frame.

### FIELD OF THE INVENTION

The present invention relates to shower door mounting brackets. More particularly, the present invention relates to a bracket system for mounting a shower door with a center pivot.

### BACKGROUND OF THE INVENTION

Conventional shower doors are commonly limited to rectangular shapes and typically are mounted to a jamb by either a hinge, such as a piano hinge, or by a pivot pin on both top and bottom, each pin pivoting within a hole in the door and the jamb. Conventionally, the pin is typically positioned proximate to one side of the top and bottom edges of the door, with the bottom pin supporting the weight of the door. The pins enable the door to pivot from the side as one pulls or pushes a door handle mounted on the door on the side opposite the pins.

It would be desirable to have a center pivot shower door bracket system that would enable an oval or other shaped shower door to be mounted at or near the center of the top and bottom edges, rather than the sides. Such a bracket system would be able to support the weight of the door, whether glass or other material, while facilitating smooth and easy opening by users. It would be desirable to have a bracket system that is easy to install, aesthetically pleasing, sturdy and low cost to manufacture.

### SUMMARY OF THE INVENTION

A bracket assembly for a center pivot door, comprising a support bracket comprising a generally flat plate, a ledge extending perpendicularly from the plate and having an aperture defined therein, two bosses extending perpendicularly from the plate, each boss having an aperture defined therein; an attachment plate comprising a generally flat member having a pair of apertures defined therein which can be aligned with the boss apertures; and, a pin having an annular ring extending therefrom, a portion of which rotatably fits within the ledge aperture. The support bracket and attachment plate are placed on either surface of a door, such as a shower door and screws are used to join the support bracket and attachment plate sandwiching the door therebetween. A second support bracket and attachment plate are mounted to the door frame. A pin is inserted into the ledge apertures of both support plates for pivotably coupling the bracket assembly to a second support bracket-attachment plate assembly so that the door can pivot about the pin axis. Bracket assemblies are mounted on the top and bottom of the door and frame. Several alternative embodiments of the ledge area and pin configuration are disclosed. Alternatively, the ledge can be curved to support the bottom edge of a curved shower door.

Other features and advantages of the present invention will become apparent upon reading the following detailed description of embodiments of the invention, when taken in conjunction with the appended claims.

### BRIEF DESCRIPTION OF THE DRAWINGS

The invention is illustrated in the drawings in which like reference characters designate the same or similar parts throughout the figures of which:

FIG. 1 is a perspective view of a center-pivot shower door and associated frame showing one exemplary embodiment of the bracket assemblies of the present invention.

FIG. 2 is a perspective view of a bracket assembly of one exemplary embodiment of the present invention with a section of shower door shown mounted therein.

FIG. 3 is a front elevational view of the main bracket of FIG. 2.

FIG. 4 is a top plan view of the main bracket of FIG. 2.

FIG. 5 is a side elevational view of the main bracket of FIG. 2.

FIG. 6 is a front elevational view of the attachment plate of FIG. 2.

FIG. 7 is a top plan view of the attachment plate of FIG. 2.

FIG. 8 is a rear elevational view of the attachment plate of FIG. 2.

FIG. 9 is a plan view of the pin in one exemplary embodiment of the present invention.

FIG. 10 is a front elevational view of a pair of bracket assemblies of FIG. 2 with a pin inserted therebetween.

FIG. 11 is a side elevational view of a pair of bracket assemblies of FIG. 2 with a pin inserted therebetween and showing a portion of the glass door.

FIG. 12 is a front elevational view of a second exemplary embodiment of a main bracket of the present invention.

FIG. 13 is a plan view of the pin in a first alternative exemplary embodiment of the present invention.

FIG. 14 is a plan view of the pin in a second alternative exemplary embodiment of the present invention.

FIG. 15 is a front elevational view of a third alternative exemplary embodiment of the present invention.

FIG. 16 is a perspective view of a fourth alternative exemplary embodiment of a main bracket and attachment plate.

### DETAILED DESCRIPTION OF THE INVENTION

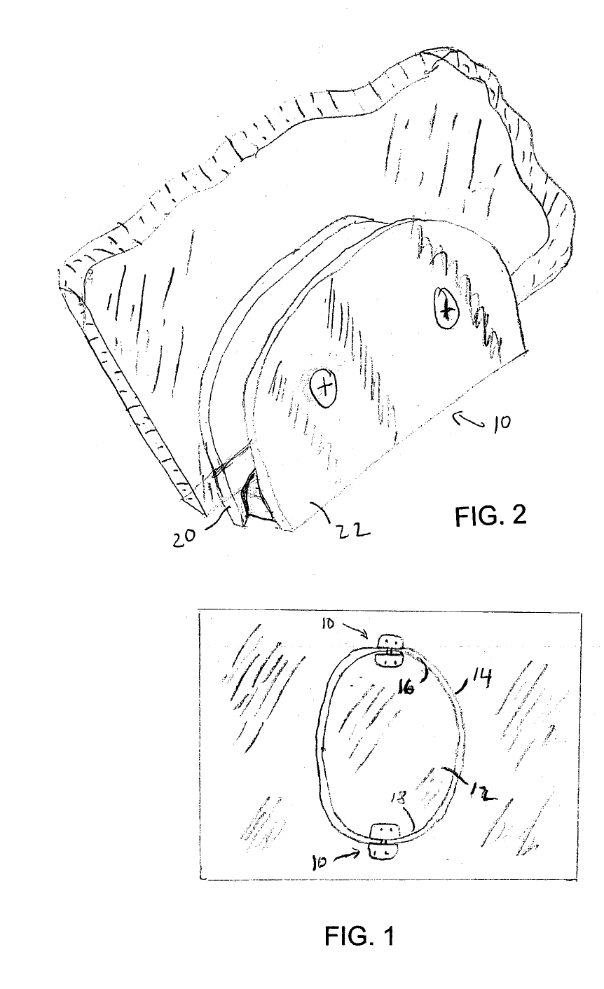

FIGS. 1 and 2 show one exemplary embodiment of a door bracket assembly 10 of the present invention as mounted to an oval shaped shower door 12 and to a door frame 14. The door 12 has a top edge area 16 and bottom edge area 18. The shower door 12 may be made of any suitable generally rigid material, and, for the exemplary and nonlimiting purposes of the present disclosure will be discussed as being made of glass. The assembly 10 generally comprises a main bracket 20, an attachment plate 22 and a pin 24. The main bracket 20, attachment plate 22 and pin 24 are preferably made of a strong rigid material, such as, but not limited to, metal, plastic, ceramic, composite or mixtures thereof. The pin 24 is preferably made of plastic and is preferably wear resistant.

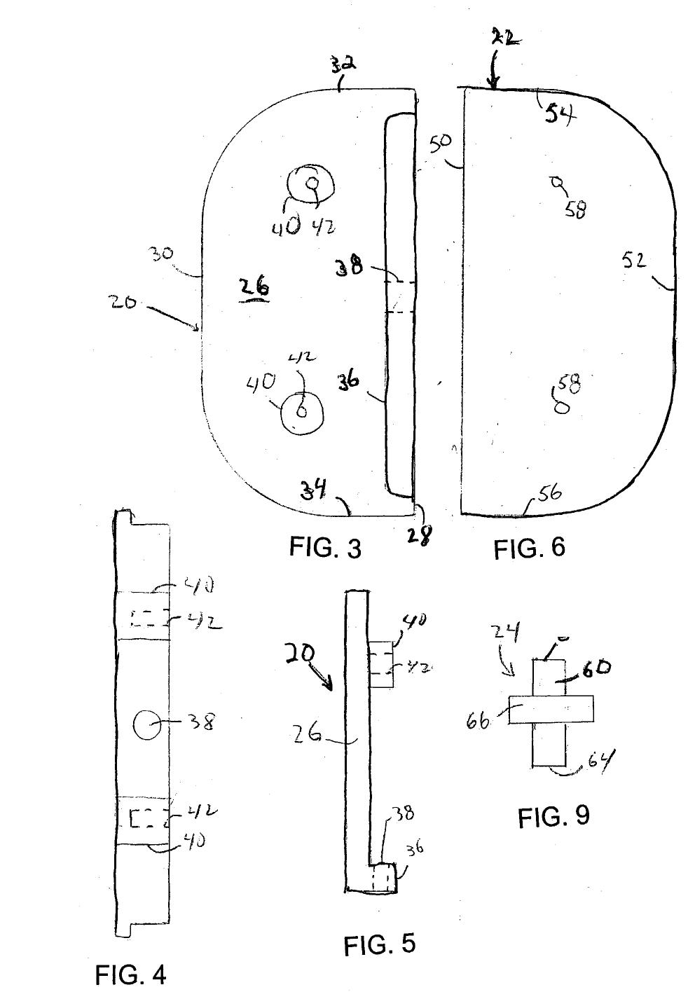

The main bracket 20, shown in FIGS. 3-5, comprises a generally flat plate 26 having a generally straight bottom edge 28, top edge 30 and opposing sides 32 and 34, with the sides 32 and 34 preferably being curved to reduce stress on the door 12 when mounted in the bracket assembly 10. A ledge 36 extends perpendicularly outward from the bottom edge 28. The ledge 36 can be a single unit or two or more ledge segments. An aperture 38 is defined in the ledge 36 suitable for receiving a portion of the pin 24. Alternatively, the aperture 38 can be defined by the gap between two ledge segments. At least one, and preferably two bosses 40 extend perpendicularly from the plate 26 on the same side as the ledge 36. Each boss 40 can be cylindrical in shape or of other shape or geometry. A cylindrical or curved cross-sectional shape is preferable so as to minimize stress points on the door 12 when mounted thereto. A bore 42, preferably threaded, extends at least partially through the boss 40 and the bore 42 is capable of receiving a screw 44 (preferably threaded). It is to be understood that the screw 44 can alternatively be a pin, bolt or the like and may be threaded or unthreaded and may include a nut (not shown).

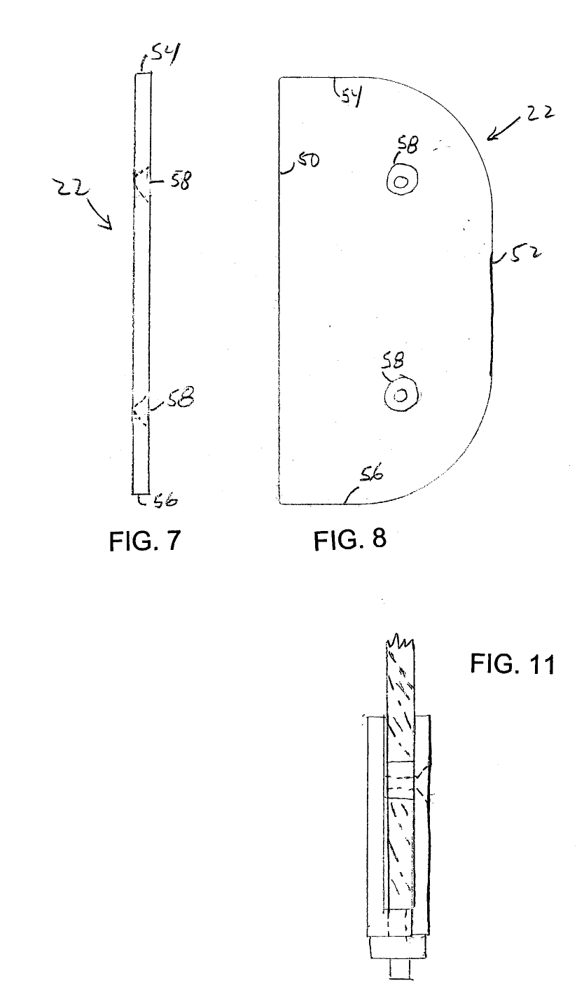

The attachment plate 22, shown in FIGS. 6-8, is generally flat, preferably, although not mandatorily, having a similar perimeter shape as the main bracket flat plate 26, with a generally straight bottom edge 50, top edge 52 and opposing sides 54 and 56, with the sides 54 and 56 preferably being curved. At least one, and preferably two apertures 58 are defined in the plate 22, corresponding in placement to the boss bore 42. Preferably each aperture 58 is beveled so as to be able to accept a preferably beveled head screw 44 so as to provide a flush and smooth surface. It is to be understood that a non-beveled aperture 58 can be used, such as with a round head screw or an ornamental screw or bolt.

The pin 24, as shown in one exemplary embodiment in FIG. 9, comprises an axle 60 having a top end 62 and a bottom end 64 and an annular ring section 66 disposed generally midpoint between the top end 62 and bottom end 64. It is to be understood that the ring 66 alternatively may be located towards one end or the other of the axle 60. It is to be further understood that alternatively two or more rings 66 can be disposed between the top and bottom ends 62, 64 and spaced apart. Preferably, the axle has parallel sides, but, alternatively, the sides can be tapered.

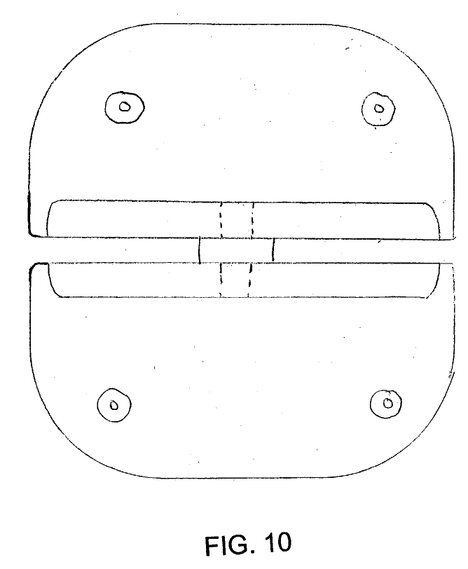

FIGS. 10-11 show the bracket assembly 10 with the top end 62 of the pin 24 inserted in an aperture 38 of one bracket 20 and the bottom end 64 of the pin 24 inserted in an aperture 38 of another bracket 20. To assemble and mount one bracket assembly 10 to the door 12, at least one, and preferably two holes are cut in the door 12 into which are inserted the bosses 40 (see FIG. 11). The bottom of the door 12 rests on the ledge 36. The plate 22 is positioned to mate with the bracket 20 with the glass door 12 sandwiched therebetween. A screw 44 is inserted through each aperture 58, through the door 12 and into the (preferably threaded) boss 40. The screw 44 is tightened secure the bracket assembly 10 together. One end of the pin 24 is inserted into the aperture 38 so that the upper side of the ring 66 abuts or is in proximity to the bottom of the ledge 36.

A duplicate bracket assembly 10 is mounted to the bottom 18 of the door frame 14. The bottom end 64 of the pin is inserted into the aperture 38 of this assembly 10, resulting in a pivoting assembly of two bracket assemblies 10 on the bottom of the door 12 area. A duplicate pair of bracket assemblies 10 are mounted to the top of the door 12 and the top 16 of the frame 14, as shown in FIG. 1 and pivotably connected by a pin 24, as heretofore described.

In operation, one side edge or area of the door 12 can be pushed or pulled (e.g., by an optional handle (not shown) mounted to the door 12) and the door pivots on the pins 24 so that a user can pass through the frame and into or out of the shower area.

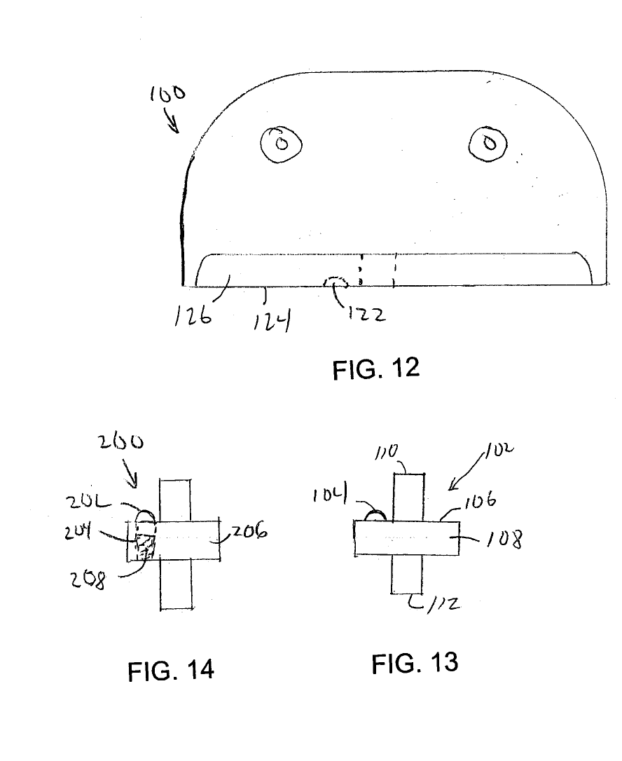

In a first alternative exemplary embodiment of a bracket assembly 100, shown in FIG. 12, a pin 102, seen in detail in FIG. 13, can have a protrusion 104, which preferably rounded, on the top side 106 of the ring 108. The pin has a top end 110 and a bottom end 112. In this embodiment a main bracket 120 has a detent or recess 122 on the bottom side 124 of the ledge 126. The support plate 22 is essentially the same as described hereinabove. When the top end 110 of the pin 102 is inserted into the aperture 128, the protrusion 104 can removably lodge in the recess 122. In this embodiment, the door 12 can be preferably maintained in a particular orientation, such as parallel to the door frame 14, until moved by a user and the protrusion 102 dislodged from the recess 122.

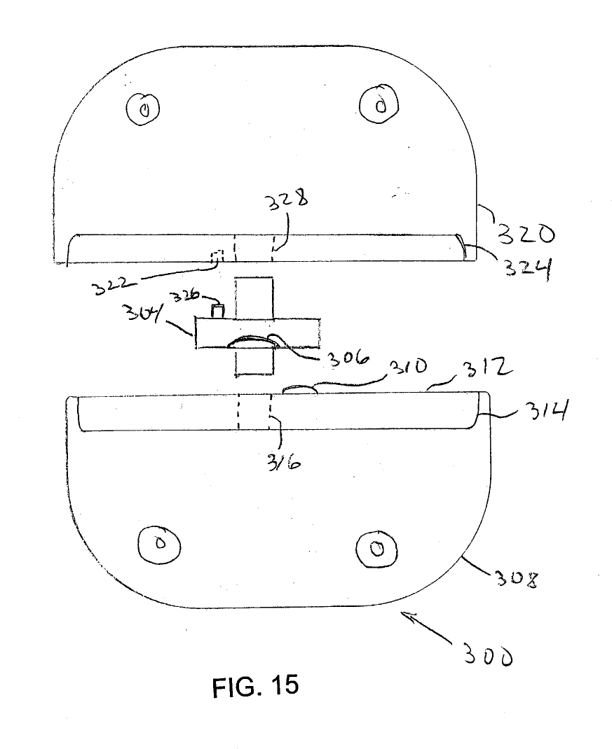

In a second alternative exemplary embodiment, shown in FIG. 14, a pin 200 has a protrusion 202 which is slidingly received in an aperture 204 in the ring 206. In the aperture 204 is a spring 208 biased against the protrusion 202, which allows the protrusion 202 to retract within the aperture 204 when a downward force is encountered. In a third alternative exemplary embodiment of a bracket assembly 300, shown in FIG. 15, a pin 302 has a ring 304 with a curved or angled notch 306. A main bracket 308 is similar to the bracket 20, but has a protrusion 310 on an edge 312 of a ledge 314. The pin 302 is inserted into an aperture 316 and, when the door pivots, the pin 302 turns and the notch 306 aligns with the protrusion 310, causing the protrusion 310 to be retained in the protrusion 310. In this manner the door is maintained or biased in a particular orientation, such as being closed (i.e., parallel to the frame) until a user pivots the door and causes the notch 306 to become misaligned with the protrusion 310. An attachment plate (not shown in FIG. 14) is essentially the same as described hereinabove.

Optionally, a bracket 320 may be the upper bracket of a bracket assembly 300 and may have a recess 322 in the ledge 324 for receiving a protrusion 326 on the pin 302. When the pin 302 is inserted into the aperture 328 in the bracket 320 it is rotated until the protrusion 326 fits in the aperture recess 322. In this manner the pin 302 is maintained in a fixed orientation with respect to the door 12 and when the door 12, bracket assembly 320 and pin 302 are pivoted, the notch 306 will pivot into alignment with the protrusion 310 resulting in the door 12 being maintained in a given orientation until repivoted so that the notch 306 and protrusion 310 are misaligned. The attachment plate (not shown in FIG. 14) for the bracket 320 is essentially the same as described hereinabove. With these designs of the brackets 308 and 320 acting in a co-operative manner, the door 12 can be accurately maintained in a closed position with respect to the frame 14 until pivoted.

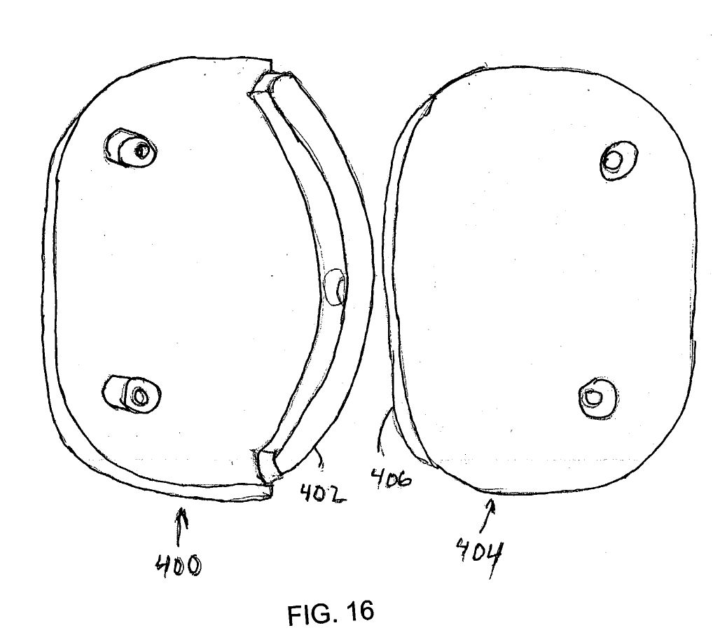

In a fourth alternative exemplary embodiment, shown in FIG. 16, a bracket 400 is essentially the same as the bracket 20, and alternatives, as described hereinabove, but has a curved ledge 402. Optionally, an attachment plate 404 is essentially the same as the attachment plate described hereinabove with a straight bottom edge, or can have (as shown in FIG. 16, a curved bottom edge 406. The pin (not shown) is essentially the same as the pin described hereinabove. The curved ledge 402 can cup and support a curved (e.g., oval) door bottom and reduce any sharp edges and stress points.

An advantage of the present invention is that the bracket assembly is easily manufactured, each assembly being only three parts. Further, the bracket assembly is easily installed, with minimal specialized instruction required. It maintains the shower door in a sturdy and solid alignment with the door frame, yet is able to pivot with little effort. Where the door is a regular shape, e.g., rectangular, it can pivot a full 360 degrees. The combination of the ledge 36 and boss(es) 40 support and distribute the weight of the door. By enabling a center pivot, oval, circular and other regular or irregular shaped doors can be used, which are currently unable to be practicably installed with conventional mounting brackets.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. It should further be noted that any patents, applications and publications referred to herein are incorporated by reference in their entirety.

I claim:

1. A bracket assembly for mounting a center pivot door, comprising:
a) a bracket comprising
i) a generally flat member,
ii) a ledge extending perpendicularly from said flat member, said ledge having a top edge and a bottom edge, said ledge having an aperture defined therein extending at least partially between said ledge top edge and said ledge bottom edge,
iii) at least one boss extending perpendicularly from said flat member, said at least one boss having a bore extending at least partially therethrough;
b) an attachment plate comprising a generally flat member having at least one aperture defined therein; and,
c) a pin receivable by said aperture for pivotably coupling said bracket and said attachment plate, said pin having a generally annular ring extending therefrom.

2. The bracket assembly of claim 1, wherein at least a portion of said flat member has a curved edge.

3. The bracket assembly of claim 1, wherein said bore of said at least one boss is threaded.

4. The bracket assembly of claim 1, wherein said attachment plate has a perimeter shape and size essentially the same as said flat member.

5. The bracket assembly of claim 1, wherein said flat member and said attachment plate are made of metal.

6. The bracket assembly of claim 1, wherein said at least one aperture in said attachment plate is beveled for receiving a countersink screw.

7. The bracket assembly of claim 1, wherein said ledge is curved.

8. A bracket assembly for mounting a center pivot door, comprising:
a) a bracket comprising
i) a generally flat member,
ii) a ledge extending perpendicularly from said flat member, said ledge having a top edge and a bottom edge, said ledge having an aperture defined therein extending at least partially between said ledge top edge and said ledge bottom edge, said bottom ledge having a notch defined therein,
iii) at least one boss extending perpendicularly from said flat member, said at least one boss having a bore extending at least partially therethrough;
b) an attachment plate comprising a generally flat member having at least one aperture defined therein; and,
c) a pin receivable by said aperture for pivotably coupling said bracket and said attachment plate, said pin having a generally annular ring extending therefrom having a top surface and a bottom surface, said annular ring having a protrusion on said top surface for removably mating with said notch.

9. A bracket assembly for mounting a center pivot door, comprising:
a) a bracket comprising
i) a generally flat member,
ii) a ledge extending perpendicularly from said flat member, said ledge having a top edge and a bottom edge, said ledge having an aperture defined therein extending at least partially between said ledge top edge and said ledge bottom edge, said bottom ledge having a notch defined therein,
iii) at least one boss extending perpendicularly from said flat member, said at least one boss having a bore extending at least partially therethrough;
b) an attachment plate comprising a generally flat member having at least one aperture defined therein; and,
c) a pin receivable by said aperture for pivotably coupling said bracket and said attachment plate, said pin having a generally annular ring extending therefrom having a top surface and a bottom surface, said annular ring having a bore extending at least partially into said top surface of said ring and generally parallel to the axis of said pin, a spring disposed within said ring bore, and, a sliding pin slidingly disposed within said ring bore.

10. A bracket assembly for mounting a center pivot door, comprising:
a) a bracket comprising
i) a generally flat member,
ii) a ledge extending perpendicularly from said flat member, said ledge having a top edge and a bottom edge, said ledge having an aperture defined therein extending at least partially between said ledge top edge and said ledge bottom edge, said bottom ledge having a notch defined therein,
iii) at least one boss extending perpendicularly from said flat member, said at least one boss having a bore extending at least partially therethrough;
b) an attachment plate comprising a generally flat member having at least one aperture defined therein; and,
c) a pin receivable by said aperture for pivotably coupling said bracket and said attachment plate, said pin having a generally annular ring extending therefrom having a top surface and a bottom surface, said annular ring having a protrusion on said top surface for removably mating with said notch.

11. A bracket system for mounting a center pivot door, comprising:
a) a first bracket assembly comprising,
i) a first bracket comprising
(1) a generally flat member,
(2) a ledge extending perpendicularly from said flat member, said ledge having a top edge and a bottom edge, said ledge having an aperture defined therein extending at least partially between said ledge top edge and said ledge bottom edge
(3) at least one boss extending perpendicularly from said flat member, said at least one boss having an aperture defined therein;
ii) an attachment plate comprising a generally flat member having at least one aperture defined therein; and,
iii) a pin for pivotably coupling said bracket and said attachment plate, said pin having a generally annular ring extending therefrom.
b) a second bracket assembly comprising,
i) a second bracket comprising
(1) a generally flat member,
(2) a ledge extending perpendicularly from said flat member, said ledge having a top edge and a bottom edge, said ledge having an aperture defined therein extending at least partially between said ledge top edge and said ledge bottom edge,
(3) at least one boss extending perpendicularly from said flat member, said at least one boss having an aperture defined therein, and,
ii) an attachment plate comprising a generally flat member having at least one aperture defined therein.

12. A bracket system for mounting a center pivot door, comprising:
a) a first bracket assembly comprising,
i) a first bracket comprising
(1) a generally flat member,
(2) a ledge extending perpendicularly from said flat member, said ledge having a top edge and a bottom edge, said ledge having a protrusion extending from said bottom edge of said ledge,
(3) at least one boss extending perpendicularly from said flat member, said at least one boss having an aperture defined therein;
ii) an attachment plate comprising a generally flat member having at least one aperture defined therein; and,
iii) a pin for pivotably coupling said bracket and said attachment plate, said pin having a generally annular ring extending therefrom, said ring having a top surface and a bottom surface, said bottom surface having a depression formed therein, and,
b) a second bracket assembly comprising,
i) a second bracket comprising
(1) a generally flat member,
(2) a ledge extending perpendicularly from said flat member, said ledge having a top edge and a bottom edge, said ledge having an aperture defined therein extending at least partially between said ledge top edge and said ledge bottom edge,
(3) at least one boss extending perpendicularly from said flat member, said at least one boss having an aperture defined therein, and,
ii) an attachment plate comprising a generally flat member having at least one aperture defined therein.

13. The bracket system of claim 12, said pin further comprising a protrusion extending upward from said top surface and said second bracket further comprising a recess defined in said ledge for removably receiving said pin protrusion.

14. A bracket, comprising a generally flat rectangular plate having a top edge, bottom edge and first side and second side, said top edge curving toward said first side and said second side, a ledge extending perpendicularly from said bottom edge, said ledge having a top edge and a bottom edge, said ledge having an aperture defined therein extending at least partially between said ledge top edge and said ledge bottom edge, said plate further comprising at least one boss extending perpendicularly therefrom, said at least one boss having an aperture defined therein.

15. The bracket of claim 14, wherein said at least one boss aperture is threaded.

16. The bracket of claim 14, wherein said bottom edge of said ledge has a recess defined therein.
